(19) United States
(12) Patent Application Publication
(10) Pub. No.: US 2022/0160462 A1
(43) Pub. Date: May 26, 2022

(54) CONNECTION ADAPTOR FOR USE WITH DENTAL TOOLS

(71) Applicant: Michael Allan Wickheim, Sooke (CA)

(72) Inventor: Michael Allan Wickheim, Sooke (CA)

(21) Appl. No.: 17/532,771

(22) Filed: Nov. 22, 2021

(30) Foreign Application Priority Data
Nov. 20, 2020 (CA) 3100277

(51) Int. Cl. A61C 1/08; A61C 1/12; A61C 17/02

(52) U.S. Cl. CPC A61C 1/088; A61C 17/0208; A61C 1/12

(57) ABSTRACT

A connection adaptor device for dental tools that provides an ergonomic operation of dental tools. The connection adaptor device includes a connector body with a first end and a second end. A tool receiver port is located at the first end. The tool receiver port is configured to be releasably attachable to dental tools. A hose receiver port is located at the second end. The hose receiver port is configured to be releasably attachable to a suction hose. An airflow passageway connects the tool receiver port to the hose receiver port. The airflow passageway having a bend at acute angle.

### FIELD OF THE INVENTION

The present invention relates to the field of dental tools.

### BACKGROUND OF THE INVENTION

Particularly in response to the global pandemic of COVID-19, dental hygienists and dental assistants have been mandated to employ the use of a relatively new oral suctioning device, the high-volume evacuator (HVE). Referring to FIG. 1, the HVE includes a HVE tip 6 that has a larger bore size than other dental suction tips to allow for higher volume extraction. The HVE may also include a handle 5 that is attached to the HVE tip 6 at one end and a suction hose 7 at the other. The HVE enhances the removal of oral secretions, splash, splatter and aerosolized particles or droplets associated with oral dental care.

Dental hygienists work in an environment where airborne contamination through oral secretions is continuously generated. Due to their proximity and protracted exposure to such contaminants, this group is considered to be the most at-risk group for exposure to COVID-19 and other biohazardous pathogens among healthcare professionals.

As with many workplace procedures and policy adjustments due to COVID-19, mandating the use of the HVE and the design of the HVE apparatus itself have been implemented hastily without due consideration for adequate safety and ergonomic measures.

One unintended consequence to the use of the HVE is that excessive and potentially injurious leverage and load is conveyed to the handle of the HVE by the weight of the suction hose to which the handle is secured. This can place work related strain upon the operator's hand, wrist, arm, neck, shoulder and upper and lower back and result in fatigue and injury in these areas.

As can be seen in FIG. 2, the suction hose 7 extends from the top of the handle 5 and arcs broadly outwards acting as a force multiplier of the suction hose's weight on the top of the HVE handle. This leverage and load must be constantly countered by the operator in order to position the HVE tip 6 for proper use, placing strain upon the operator's hand and other associated parts of the body. In handle positions other than vertical, this leveraging force can be even greater, thus further increasing the potential for Musculo-Skeletal Injury or Disease (MSI's or MSD's, respectively).

### SUMMARY OF THE INVENTION

In one aspect, the present invention provides a connection adaptor device for dental tools that allows for an ergonomic operation of dental tools. To reduce the leverage and load applied by the broad arc of the suction hose as it exits the top of the HVE handle, the connection adaptor device is designed to eliminate a large percentage of the lateral extension of the suction hose and thereby decrease the load transmitted to the operator's hand, arm and torso.

The connection adaptor device includes a connector body with a first end and a second end. A tool receiver port is located at the first end. The tool receiver port is configured to be releasably attachable to dental tools. A hose receiver port is located at the second end. The hose receiver port is configured to be releasably attachable to a suction hose. An airflow passageway connects the tool receiver port to the hose receiver port. The connector body having a bend at an acute angle.

In one embodiment, the connection adaptor device may be configured to be positioned between a tool and a hose (or a HVE handle and a hose).

In another embodiment, the connector body includes a swivel joint that can be placed anywhere along the connector body and configured to allow the connector body to swivel on an axis.

In another embodiment, the connector body is constructed with a flexible material that allows for the angle of the bend to be adjusted.

In another embodiment, a loop or hook is attached to or forms a part of the connector body, enabling the connection adaptor device, along with any attached hoses and tools, to be hung up between uses.

In some aspects, the present invention provides a connection adaptor device for a high-volume evacuator (HVE) dental device, comprising: a body defining an inlet end leading into an inlet passage, an outlet passage terminating in an outlet end, and a bend connecting the inlet passage to the outlet passage in an acute angle; the inlet end defining a tool receiver port being configured to releasable connect to a handle of the HVE; the outlet end defining a hose receiver port configured to be releasably attachable to a suction hose of the HVE; and the inlet passage, the bend and the outlet passage defining an airflow passageway from the tool receiver port to the hose receiver port.

In some embodiments, the hose receiver port may define a tubular portion configured to closely fit within an end of the suction hose of the HVE.

In some embodiments, the apparatus may further comprise transverse ribs on the tubular portion to engage an inside surface of the suction hose and resist removal hose receiver port from the suction hose.

In some embodiments, the inlet passage may be linear and defines a central inlet passage axis, the outlet passage may be linear and defines a central outlet passage axis, and said axes are at an acute angle to each other

In some embodiments, the acute angle may be in the range of 30 degrees-80 degrees. In some embodiments, the acute angle is in the range of 40 degrees-60 degrees.

In some aspect, the present invention provides a replacement kit for an HVE dental tool comprising the connection adaptor device, a swivel adapter receivable within the tool receiver port wherein the swivel adapter is connectable to the handle of the HVE, and a length of HVE suction tubing connectable to the hose receiver port.

### SUMMARY OF THE DRAWINGS

FIGS. 1 and 2 are photographs of the prior art showing a HVE tip and HVE handle directly attached to a suction hose.

FIG. 3 is a view of a connection adaptor device in accordance with an embodiment of the present invention shown in the environment of a suction hose, HVE handle and HVE tip.

FIG. 4 is a section view of the connection adaptor device of FIG. 3.

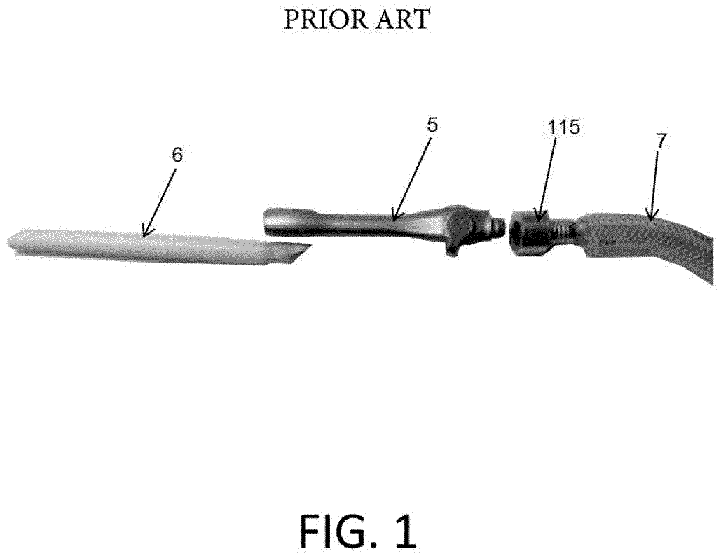

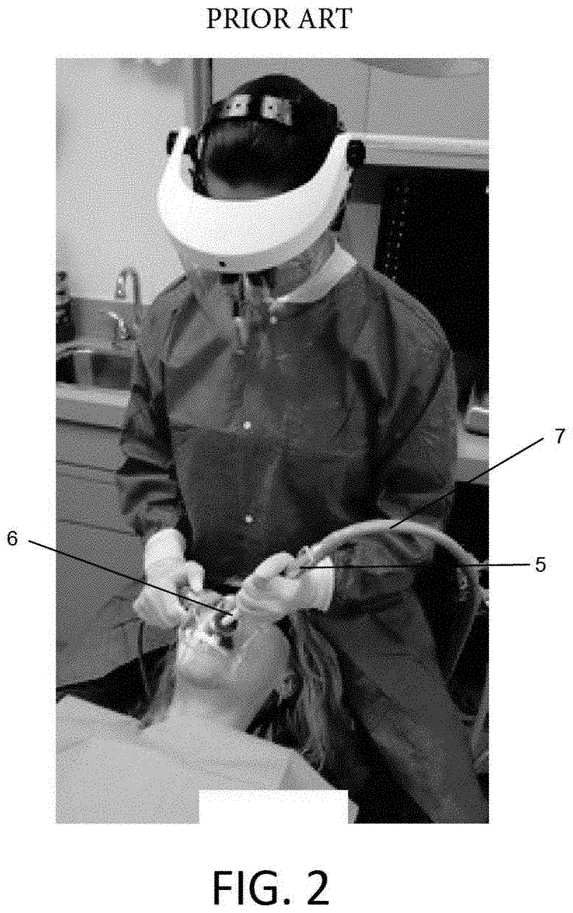

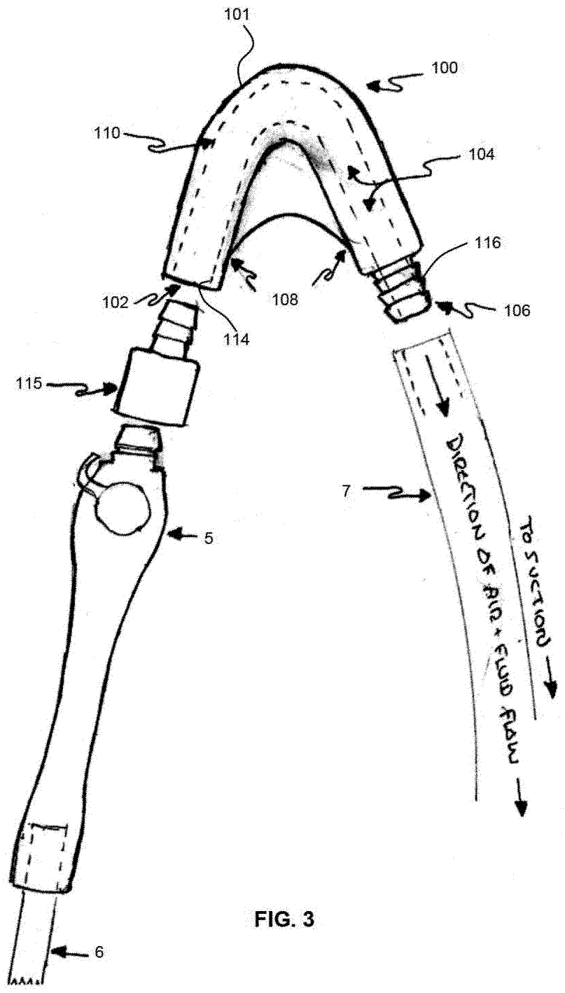

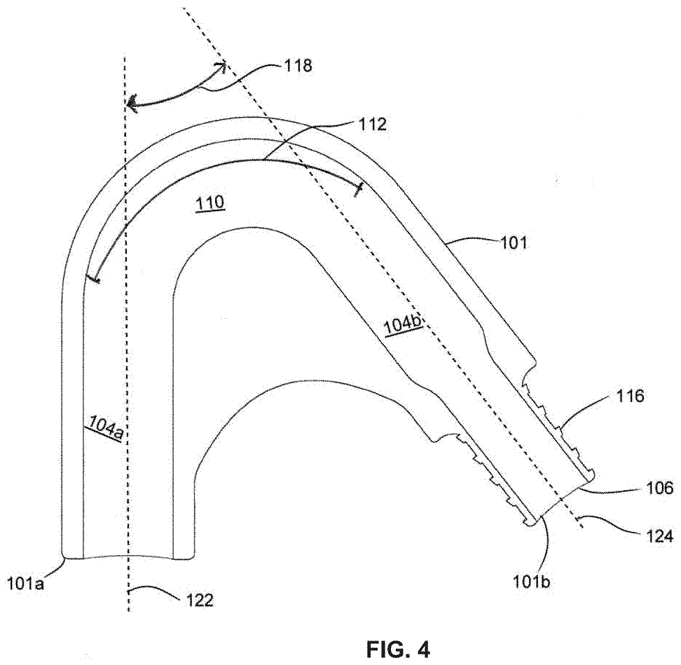

### DETAILED DESCRIPTION WITH REFERENCE TO THE DRAWINGS

As shown in the drawings, an embodiment of the present invention includes a connection adaptor 100, having a connector body 101, a tool receiver port 102, an airflow passageway 104, a hose receiver port 106, an outer surface 108, and an inner surface 110.

In one embodiment, connector body 101 is molded from medical grade plastic. However, connector body 101 may be molded, machined printed or otherwise manufactured of non-porous, moderate to high tensile strength material. The material used is preferably impervious to water penetration and/or standard chemical disinfectant bath cleaning. The material used preferably also renders connector body 101 rigid, resistant to bending or twisting forces, and resistant to distortion caused by an internal decrease in pressure related to suctioning, or stresses incurred by regular dental hygienist work. Example materials include aluminum, medical grade plastics, or other lightweight and strong materials.

The connector body 101 defines an inlet end 101a leading into an inlet passage 104a, an outlet passage 104b terminating in an outlet end 101b, and the bend 112 connects the inlet passage 104a to the outlet passage 104b in an acute angle.

The inlet end 101a defines the tool receiver port 102 being configured to releasable connect to the handle 5 of the HVE, either directly (not shown) or via swivel adapter 115. The outlet end 101b define the hose receiver port 106 configured to be releasably attachable to suction hose 7 of the HVE.

Hence the inlet passage 101a, the bend 112 and the outlet passage 101b define airflow passageway 104 extending from the tool receiver port 102 to the hose receiver port 106. Bend 112 is a bend at an acute angle 118 near the halfway point of the length of airflow passageway 104. The acute angle 118 The acute angle 118 may be in the range of 30 degrees to 80 degrees, and preferably in the range of 40 degrees to 60 degrees. While the exact value of the angle may be adjusted, an acute angle should be maintained.

Tool receiver port 102 connects connector body 101 to the handle 5 of a HVE tool or other dental tools. Tool receiver port 102 includes a female adaptor 114 configured to accommodate a swiveling adapter connection 115 typical in industry for connecting the handle 5 of a HVE suction device to a suction hose 7. The swiveling adapter connection 115 can be of different dimensions depending on manufacturer and model. The dimensions of tool receiver port 102 can be adjusted to fit different sizes of swiveling adapter connections 115 or any other dental tool connections.

In the illustrated embodiment, the inlet passage 101a is linear—i.e. resembling a straight line—and defines a central inlet passage axis 122, The outlet passage 101b is linear defining a central outlet passage axis 124, and said axes (122 and 124) are at an acute angle 118 to each other. The magnitude of the acute angle 118 may be in the range of 30 degrees to 80 degrees, and preferably in the range of 40 degrees to 60 degrees. While the exact value of the angle may be adjusted, an acute angle should be maintained.

Airflow passageway 104 is a passageway within connector body 101, connecting tool receiver port 102 to hose receiver port 106 and defined by inner surface 110 and a bend 112 at an acute angle, such as angle 118. Air and oral secretions/debris are drawn through airflow passageway 104 enroute from a HVE tip 6 and HVE handle 5 to a suction hose 7, by a remote air suction pump connected to the suction hose. Airflow passageway 104 is enclosed throughout its length and connects the handle 5 of an HVE via tool receiver port 102 to a suction hose 7 via hose receiver port 106.

Inner surface 110 is relatively smooth and without obvious obstruction or hard corners. A smooth and rounded inner surface 110 minimizes airflow turbulence and the catching or depositing of any passing debris.

If the handle 5 of a HVE device (attached to connector body 101) in its vertical orientation is considered to be “0” degrees, connector body 101 changes the suction hose connection angle relative to the handle by approximately 100 degrees to 140 degrees. This change in the hose connection angle relative to the handle assists in reducing the leverage and load generated from the suction hose arching in its standard configuration. This redirection and reduced leveraging results in reduced operator hand/wrist/arm/elbow/shoulder/neck and/or back strain. In one trial, the load measured at the top of the handle, in a typical configuration used in the prior art, was approximately 420 grams. Once connection adaptor 100 was used, the load measured at the top of the handle was reduced to 120 grams. Repeated measurements of the reduction of load stress were approximately 65% less than the standard configuration currently in use.

Hose receiver port 106 connects connector body 101 to a suction supply hose 7. Hose receiver port 106 is comprised of a male adaptor 116 to which an industry standard ½ inch or other sized suction hose may be secured. Suction hoses can be of different dimensions depending on manufacturer and model. The dimensions of hose receiver port 106 can be adjusted according to these specification needs.

Outer surface 108 is smooth with no sharp edges and a minimum of embossments or markings that could impact cleaning efficacy.

In an alternative embodiment, connector body 101 includes a swivel joint that may be positioned anywhere along connector body 101 and is configured to allow connector body 101 to swivel on an axis.

In another alternative embodiment, connector body 101 is constructed with a flexible material that allows for the angle of bend 112 to be adjusted.

In another alternative embodiment, a loop or hook is attached to or forms a part of outer surface 108, enabling connector body 101, along with any attached hoses and tools, to be hung up between uses.

It may be that there are several different hose sizes and handle styles to which connector body 101 can be attached. These may require that either tool receiver port 102 and/or hose receiver port 106 be manufactured to accommodate these alternate sizes and/or fittings and/or coupling arrangements.

The scope of the claims should not be limited by the preferred embodiments set forth in the examples but should be given the broadest interpretation consistent with the description as a whole.

What is claimed is:

1. A connection adaptor device for a high-volume evacuator (HVE) dental device, comprising:
a. a body defining an inlet end leading into an inlet passage, an outlet passage terminating in an outlet end, and a bend connecting the inlet passage to the outlet passage in an acute angle;
b. the inlet end defining a tool receiver port to releasable connect to a handle of the HVE;
c. the outlet end defining a hose receiver port to releasably attach to a suction hose of the HVE; and
d. the inlet passage, the bend and the outlet passage defining an airflow passageway from the tool receiver port to the hose receiver port.

2. The apparatus as claimed in claim 1, wherein the hose receiver port defines a tubular portion configured to closely fit within an end of the suction hose of the HVE.

3. The apparatus as claimed in claim 2, further comprising transverse ribs on the tubular portion that engage an inside surface of the suction hose and resist removal hose receiver port from the suction hose.

4. The apparatus as claimed in claim 1, wherein the acute angle is in the range of 30 degrees-80 degrees.

5. The apparatus as claimed in claim 1, wherein the acute angle is in the range of 40 degrees-60 degrees.

6. The apparatus as claimed in claim 3, wherein the acute angle is in the range of 30 degrees-80 degrees. The apparatus as claimed in claim 3, wherein the acute angle is in the range of 40 degrees-60 degrees.

8. The apparatus as claimed in claim 1, wherein the inlet passage is linear and defines a central inlet passage axis, the outlet passage is linear defines a central outlet passage axis, and said axes are at an acute angle to each other.

9. The apparatus as claimed in claim 4, acute angle is in the range of 30 degrees-80 degrees.

10. The apparatus as claimed in claim 4, wherein the acute angle is in the range of 40 degrees-60 degrees.

11. A replacement kit for an HVE dental tool comprising the apparatus as claimed in claim 1, a swivel adapter receivable within the tool receiver port wherein the swivel adapter is connectable to the handle of the HVE, and a length of HVE suction tubing connectable to the hose receiver port.

12. A replacement kit for an HVE dental tool comprising the apparatus as claimed in claim 8, a swivel adapter receivable within the tool receiver port wherein the swivel adapter is connectable to the handle of the HVE, and a length of HVE suction tubing connectable to the hose receiver port.
